(19) United States
(12) Patent Application Publication
(10) Pub. No.: US 2024/0157819 A1
(43) Pub. Date: May 16, 2024

(54) DIRECT CURRENT FAST CHARGER CONTROL METHOD FOR VEHICLE WITH MULTI-PORT CHARGING SYSTEM

(71) Applicant: GM Global Technology Operations LLC, Detroit, MI (US)

(72) Inventors: Chandra S. Namuduri, Troy, MI (US); Suresh Gopalakrishnan, Troy, MI (US); Venkata Prasad Atluri, Novi, MI (US); Lei Hao, Troy, MI (US); Yue-Yun Wang, Troy, MI (US); Ibrahim Haskara, Macomb, MI (US)

(21) Appl. No.: 17/986,246

(22) Filed: Nov. 14, 2022

(51) Int. Cl. B60L 53/10; B60L 53/62; B60L 58/12; B60L 58/21

(52) U.S. Cl. CPC B60L 53/11; B60L 53/62; B60L 58/12; B60L 58/21

(57) ABSTRACT

An electric vehicle, system and method of charging the electric vehicle. In another exemplary embodiment, a system for charging an electric vehicle is disclosed. The system includes a first battery subpack, a second battery subpack, and a processor. The processor is configured to determine a selected battery subpack from the first battery subpack and the second battery subpack for charging based on a comparison of a first state of charge of the first battery subpack a second state of charge of the second battery subpack and connect the selected battery subpack to a corresponding one of a first charge port and a second charge port.

### INTRODUCTION

The subject disclosure relates to electric vehicles and, in particular, to a system and method for charging electric vehicles operating off of a plurality of battery subpacks.

Medium duty to Heavy duty electric vehicles operate using high voltage battery sources. Charging the battery sources can be a time-consuming operation, due to the amount of charging necessary as well as to limits on the rate at which charging can be performed to prevent overheating. Accordingly, it is desirable to provide a battery system that can be charged with reduced charging times.

### SUMMARY

In one exemplary embodiment, a method of charging an electric vehicle is disclosed. A first state of charge of a first battery subpack is detected. A second state of charge of a second battery subpack is detected. A selected battery subpack is determined from the first battery subpack and the second battery subpack for charging based on a comparison of the first state of charge and the second state of charge. The selected battery subpack is connected to a corresponding one of a first charge port and a second charge port.

In addition to one or more of the features described herein, the method further includes charging the selected battery subpack in a constant current charging mode until a cell voltage of a battery cell of the selected battery subpack reaches a voltage threshold and charging the selected battery subpack using a constant voltage charging mode when the cell voltage of the battery cell is greater than the voltage threshold. The method further includes providing power from the selected battery subpack to an accessory load while the selected battery subpack is being charged and switching the accessory load off the selected battery subpack once the selected battery subpack is fully charged. The method further includes disconnecting the selected battery subpack from one of the first charge port and the second charge port when the selected battery subpack is fully charged. Switching the accessory load further includes pre-charging another battery subpack prior to connecting the accessory load to the other battery subpack. In an embodiment, the first charge port and the second charge port are electrically connected and the selected battery subpack is selected by determining which of the first battery subpack and the second battery subpack has a greater state of charge. The method further includes pre-charging the selected battery subpack one and coupling the selected battery subpack to the first charge port and the second charge port prior to connecting another battery subpack to the first charge port and the second charge port.

In another exemplary embodiment, a system for charging an electric vehicle is disclosed. The system includes a first battery subpack, a second battery subpack, and a processor. The processor is configured to determine a selected battery subpack from the first battery subpack and the second battery subpack for charging based on a comparison of a first state of charge of the first battery subpack a second state of charge of the second battery subpack and connect the selected battery subpack to a corresponding one of a first charge port and a second charge port.

In addition to one or more of the features described herein, the processor is further configured to charge the selected battery subpack in a constant current charging mode until a cell voltage of a battery cell of the selected battery subpack of the selected battery subpack reaches a voltage threshold and charge the selected battery subpack using a constant voltage charging mode when the cell voltage of the battery cell is greater than the voltage threshold. The processor is further configured to allow power to be provided from the selected battery subpack to an accessory load while the selected battery subpack is being charged and switch the accessory load off the selected battery subpack once the selected battery subpack is fully charged. The processor is further configured to disconnect the selected battery subpack from the corresponding one of the first charge port and the second charge port when the selected battery subpack is fully charged. The processor is further configured to pre-charge another battery subpack prior to connecting the accessory load to the other battery subpack. In an embodiment, the first charge port and the second charge port are electrically connected and the processor is further configured to determine the selected battery subpack by determining which of the first battery subpack and the second battery subpack has a greater state of charge. The processor is further configured to pre-charge the selected battery subpack and couple the selected battery subpack to the first charge port and the second charge port prior to connecting another battery subpack to the first charge port and the second charge port.

In yet another exemplary embodiment, an electric vehicle is disclosed. The elective vehicle includes a first battery subpack, a second battery subpack, and a processor. The processor is configured to determine a selected battery subpack from the first battery subpack and the second battery subpack for charging based on a comparison of a first state of charge of the first battery subpack a second state of charge of the second battery subpack and connect the selected battery subpack to a corresponding one of a first charge port and a second charge port.

In addition to one or more of the features described herein, the processor is further configured to charge the selected battery subpack in a constant current charging mode until a cell voltage of a battery cell of the selected battery subpack reaches a voltage threshold and charge the selected battery subpack using a constant voltage charging mode when the cell voltage of the battery cell is greater than the voltage threshold. The processor is further configured to allow power to be provided from the selected battery subpack to an accessory load while the selected battery subpack is being charged and switch the accessory load off the selected battery subpack once the selected battery subpack is fully charged. The processor is further configured to disconnect the selected battery subpack from the corresponding one of the first charge port and the second charge port when the selected battery subpack is fully charged. The processor is further configured to pre-charge another battery subpack prior to connecting the accessory load to the other battery subpack. In an embodiment, the first charge port and the second charge port are electrically connected and the processor is further configured to determine the selected battery subpack by determining which of the first battery subpack and the second battery subpack has a greater state of charge.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an electric vehicle in accordance with an exemplary embodiment;

FIG. 2 shows a circuit diagram of the electrical system of the electric vehicle, in a first embodiment;

FIG. 3 is a flowchart of a method for operating the electrical system in an embodiment;

FIG. 4 shows a continuation of the flowchart of FIG. 3;

FIG. 5 is a continuation of the flowchart of FIG. 3;

FIG. 6 is a continuation of the flowchart of FIG. 3;

FIG. 7 shows a flowchart of a method for switching an accessory load between battery subpacks;

FIG. 8 shows a circuit diagram of the electrical system, in a second embodiment;

FIG. 9 shows a circuit diagram of the electrical system, in a third embodiment;

FIG. 10 shows a circuit diagram of the electrical system, in a fourth embodiment;

FIG. 11 shows a circuit diagram of the electrical system, in a fifth embodiment;

FIG. 12 shows a flowchart illustrating a charging method using the fifth embodiment of the electrical system shown in FIG. 11;

FIG. 13 is a continuation of the flowchart of FIG. 12; and

FIG. 14 is a continuation of the flowchart of FIG. 12.

### DETAILED DESCRIPTION

The following description is merely exemplary in nature and is not intended to limit the present disclosure, its application or uses. It should be understood that throughout the drawings, corresponding reference numerals indicate like or corresponding parts and features.

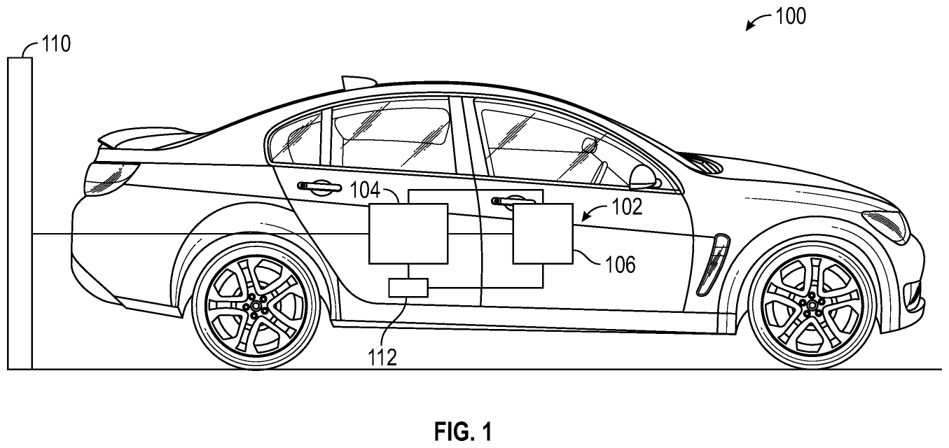

In accordance with an exemplary embodiment, FIG. 1 shows an electric vehicle 100. The electric vehicle 100 includes an electrical system 102 including a battery system 104 and an electrical load 106 which operates using power provided by the battery system. The electrical load 106 can include accessory loads, such as radio, air conditioning, power windows, etc. As shown in FIG. 1, the vehicle is plugged into a charging station 110 which charges the battery system 104.

The electric vehicle 100 further includes a controller 112. The controller 112 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 112 may include a non-transitory computer-readable medium that stores instructions which, when processed by one or more processors of the controller 112, implement a method of controlling a charging operation for the battery system 104.

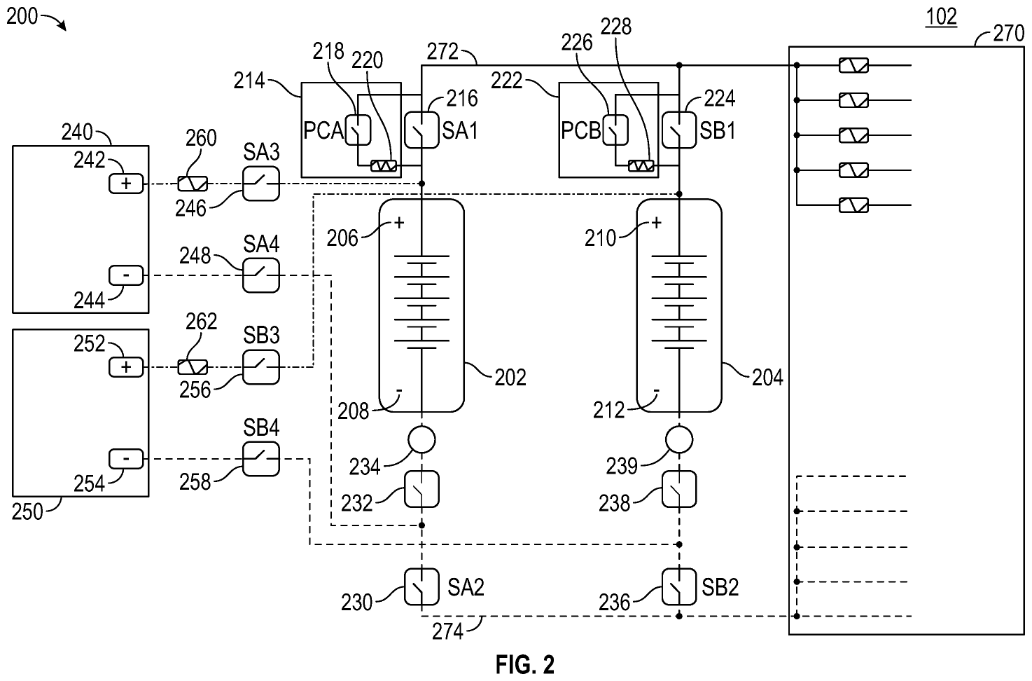

FIG. 2 shows a circuit diagram 200 of the electrical system 102 of the electric vehicle 100, in a first embodiment. The electrical system 102 includes a first battery subpack 202 and a second battery subpack 204. The electrical system 102 can also include various sensors (not shown) for detecting parameters of the battery subpacks, such as voltage levels, states of charges, current, temperature, etc. The first battery subpack 202 and the second battery subpack 204 are high voltage battery subpacks. Each battery subpack includes a plurality of battery cells. In an embodiment, at least one of the first battery subpack 202 and the second battery subpack 204 can hold a voltage of 800 Volts (V) when fully charged. The first battery subpack 202 includes a first positive terminal 206 and a first negative terminal 208. The second battery subpack 204 includes a second positive terminal 210 and a second negative terminal 212. The first battery subpack 202 and the second battery subpack 204 are in parallel with each other and with accessory loads 270 of the electrical load 106 via a high voltage (HV) positive bus 272 at the positive terminals and a HV negative bus 274 at the negative terminals.

A first pre-charge device 214 and a first main switch 216(SA1) are located between the first positive terminal 206 of the first battery subpack 202 and the HV positive bus 272. The first pre-charge device 214 runs parallel to the first main switch 216 (SA1) and includes a first pre-charge switch 218 (PCA) and a first pre-charge resistor 220. In general operation, the first main switch 216 (SA1) is closed and the first pre-charge switch 218 (PCA) is open, allowing current to bypass the first pre-charge resistor 220. During a pre-charging operation, the first main switch 216 (SA1) is open and the first pre-charge switch 218 (PCA) is closed, causing current to flow through the first pre-charge resistor 220, thereby limiting an inrush current along the HV positive bus 272 and at the accessory loads 270.

Similarly, a second pre-charge device 222 and a second main switch 224(SB1) are located between the second positive terminal 210 of the second battery subpack 204 and the HV positive bus 272. The second pre-charge device 222 runs parallel to the second main switch 224 (SB1) and includes a second pre-charge switch 226 (PCB) and a second pre-charge resistor 228. In a general operation, the second main switch 224 (SB1) is closed and the second pre-charge switch 226 (PCB) is open, allowing current to bypass the second pre-charge resistor 228. During a pre-charging operation, the second main switch 224 (SB1) is open and the second pre-charge switch 226 (PCB) is closed, causing current to flow through the second pre-charge resistor 228, thereby limiting an inrush current along the HV positive bus 272 and at the accessory loads 270.

At the first battery subpack 202, a first return switch 230 (SA2), a first fuse 232 (Pyro 1) and a first charge port current sensor 234 are located between the first negative terminal 208 and the accessory loads 270. Similarly, at the second battery subpack 204, a second return switch 236 (SB2), a second fuse 238 (Pyro2) and a second charge port current sensor 239 are located between the second negative terminal 212 and the accessory loads 270.

During a charging operation, the first battery subpack 202 can be coupled to a first charge port 240, through which a connection is made to the charging station 110. In various embodiments, the first charge port 240 is a direct current fast charging (DCFC) port. The first charge port 240 includes a first positive charge terminal 242 and a first negative charge terminal 244. The first positive charge terminal 242 connects to the first positive terminal 206 of the first battery subpack 202. The first negative charge terminal 244 connects between the first return switch 230 (SA2) and the first fuse 232 (Pyro 1). A switch 246 (SA3) at the first positive charge terminal 242 controls a connection between the first positive charge terminal and the first positive terminal 206. A switch 248 (SA4) at the first negative charge terminal 244 controls a connection between the first negative charge terminal and the first negative terminal 208. A first charge port fuse 260 is located at the first positive charge terminal 242 and can activate or blow in the event of an overcurrent.

Similarly, during the charging operation the second battery subpack 204 can be coupled to a second charge port 250 through which a connection is made to the charging station 110. In various embodiments, the second charge port 250 is a direct current fast charging (DCFC) port. The second charge port 250 includes a second positive charge terminal 252 and a second negative charge terminal 254. The second positive charge terminal 252 connects to the second positive terminal 210 of the second battery subpack 204. The second negative charge terminal 254 connects between the second return switch 236 (SB2) and the second fuse 238 (Pyro 2). A switch 256 (SB3) at the second positive charge terminal 252 controls a connection between the second positive charge terminal 252 and the second positive terminal 210. Similarly, a switch 258 (SB4) at the second negative charge terminal 254 controls a connection between the second negative charge terminal 254 and the second negative terminal 212. A second charge port fuse 262 is located at the second positive charge terminal 252 and can activate or blow in the event of an overcurrent.

Controller 112 can be coupled to each of the switches (i.e., SA1, SA2, SA3, SA4, PCA, Pyro 1, SB1, SB2, SB3, SB4, PCB, Pyro 2) and can control operation of the switches. The controller 112 can switch the configuration of these switches to accommodate a given mode of operation of the battery subpacks, as discussed herein. It is noted that the first charge port 240 is used to charge the first battery subpack 202 and the second charge port 250 is used to charge the second battery subpack 204.

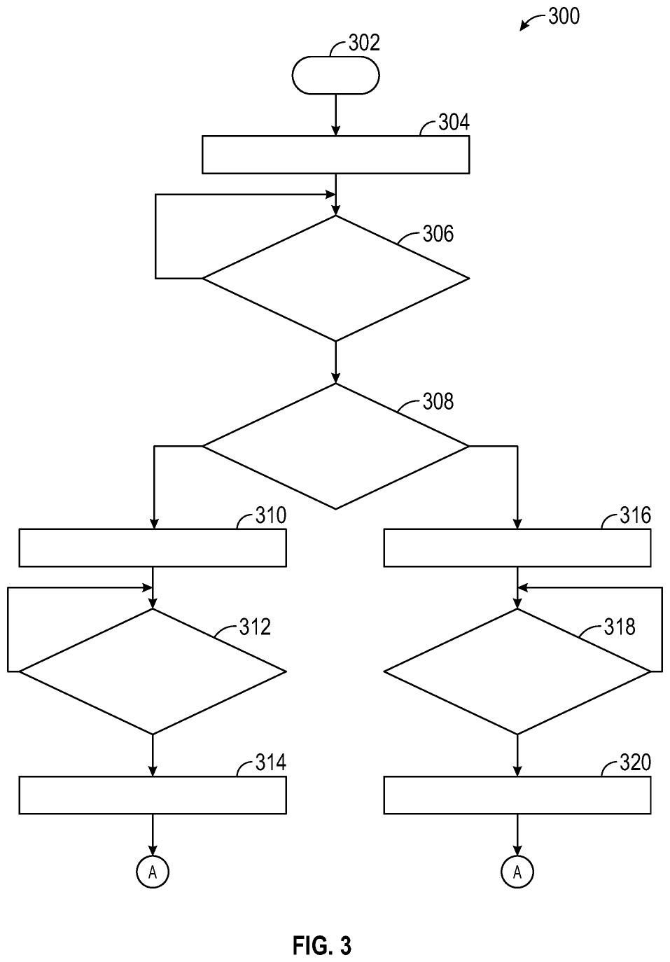

FIG. 3 is a flowchart 300 of a method for operating the electrical system in an embodiment. The method begins at box 302. In box 304, all of the switches (SA1, SA2, SA3, SA4, PCA, Pyro 1, SB1, SB2, SB3, SB4, PCB, Pyro 2) are opened. In box 306, both charge ports are checked to see if they are ready or connected for charging their respective battery subpacks. If no, the box 306 loops back into itself. If yes, the method proceeds to box 308. In box 308, the state of charge (SOC) for the battery subpacks are compared to each other. If the SOC for the first battery subpack is greater than the SOC for the second battery subpack, the method proceeds to box 310. Otherwise, the method proceeds to box 316.

Referring to box 310, the PCA switch and the SA2 switch are closed to establish a pre-charging configuration at the first battery subpack. In box 312, pre-charging is performed at the first battery subpack. A check is made to see if the pre-charging operation is completed. If no, the box 312 loops back into itself. If yes, the pre-charging is complete, and the method proceeds to box 314. In box 314, first main switch SA1 is closed and the first pre-charging switch PCA is opened.

Referring now to box 316, the PCB switch and the SB2 switch are closed to establish a pre-charging configuration at the second battery subpack. In box 318, pre-charging is performed at the second battery subpack. A check is made to see if the pre-charging operation is completed. If no, box 318 loops back into itself. If yes, the pre-charging is complete, and the method proceeds to box 320. In box 320, second main switch SB1 is closed and the second pre-charging switch PCB is opened.

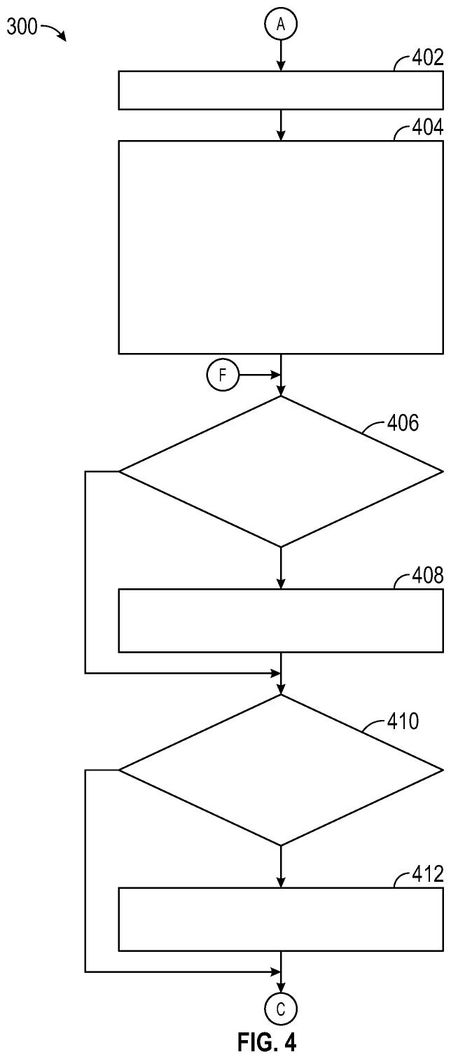

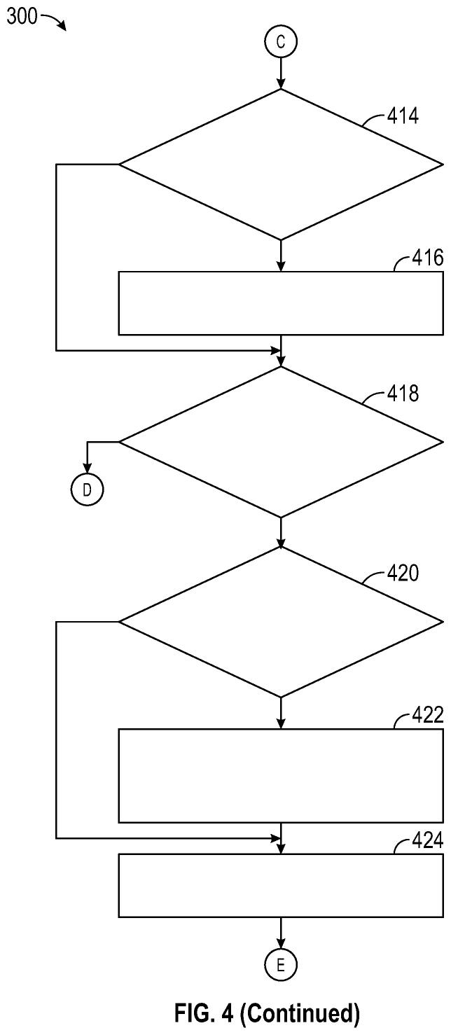

From either box 314 or box 320, the method proceeds to a charging operation as shown in FIG. 4. FIG. 4 shows a continuation of the flowchart 300 of FIG. 3. Box 402 is entered from either box 314 or box 320. In box 402, switches SA3, SA4, SB3, SB4 are closed to connect the first battery subpack to the first charge port and the second battery subpack to the second charge port. In box 404, current commands are sent to the charging ports to charge their respective battery subpacks. The charging occurs in a constant current charging mode and adjustments can be made to the current commands in order to maintain constant current charging.

In box 406, the temperatures of each battery subpack are monitored. If the temperatures of the battery subpacks are within a specified temperature range, the method proceeds directly to box 410. However, if the temperature is not within a temperature range, the method proceeds to box 408. In box 408, the charging is derated for the battery subpack that is outside of the temperature range. The method then proceeds to box 410.

In box 410, the cell voltages of the second battery subpack are compared to a voltage limit (a maximum voltage). For the second battery subpack, if none of the cells have a voltage level that is near or that has reached a maximum voltage for the cell, the method proceeds directly to box 414. However, if the voltage level for a cell of the second battery subpack is near or has reached the maximum voltage (within a criterion), the method proceeds to box 412. In box 412, the charging operation at the second battery subpack is switched from a constant current charging mode to a constant voltage charging mode. From box 412, the method proceeds to box 414.

In box 414, the cell voltages of the first battery subpack are compared to a voltage limit (a maximum voltage). For the first battery subpack, if none of the cells have a voltage level that is near or that has reached a maximum voltage for the, the method proceeds directly to box 418. However, if the voltage level for a cell of the first battery subpack is near or has reached the maximum voltage (within a criterion), the method proceeds to box 416. In box 416, the charging operation at the first battery subpack is switched from a constant current charging mode to a constant voltage charging mode. From box 416, the method proceeds to box 418.

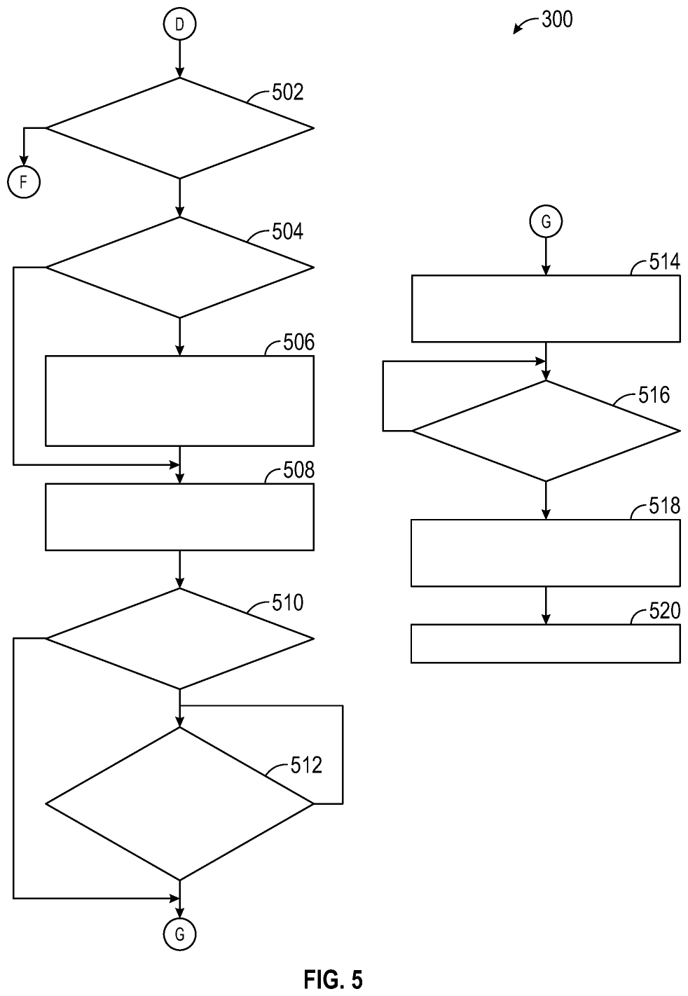

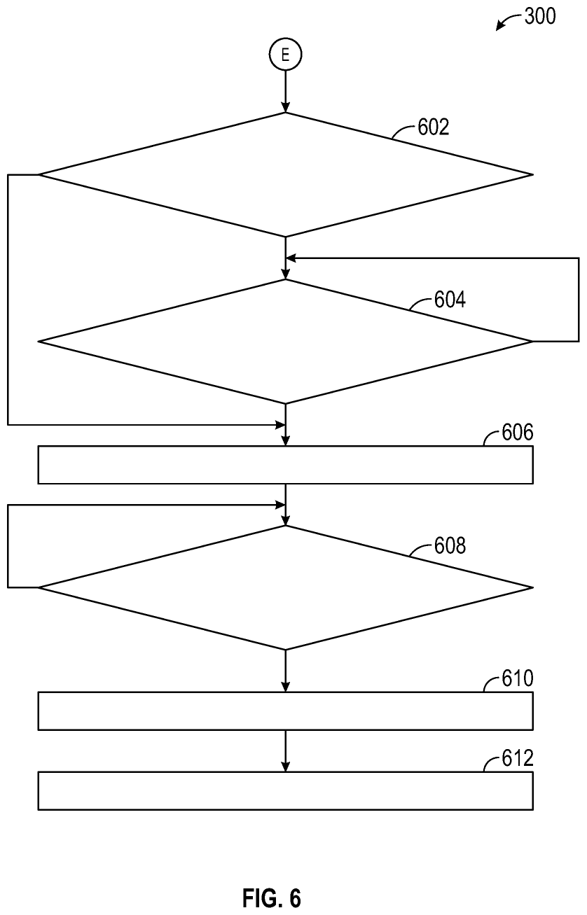

In box 418, the SOC of the first battery subpack is observed to see if the charging is complete at the first battery subpack. If the SOC has not reached an SOC limit, the method proceeds to box 502 (FIG. 5). If the SOC has reached its limit, the method proceeds to box 420. In box 420, the state of the SA1 switch is checked. If the SA1 switch is off, the method proceeds directly to box 424. However, if the SA1 switch is on, the method proceeds to box 422. In box 422, the accessory load is transitioned to the second battery subpack by closing switches SB1 and SB2 and opening switches SA1 and SA2. The method then proceeds to box 424. In box 424, the first battery subpack is disconnected from the first charge port to terminate its charging. From box 424, the method proceeds to box 602 (FIG. 6).

FIG. 5 is a continuation of flowchart 300 of FIG. 3. Box 502 is entered from box 418 (FIG. 4). In box 502, the SOC of the second battery subpack is checked to see if the charging is complete at the second battery subpack. If the SOC has not reached an SOC limit, the method returns to box 406 (FIG. 4). If the SOC has reached its limit, the method proceeds to box 504. In box 504, the state of the SB1 switch is checked. If the SB1 switch is off, the method proceeds directly to box 508. However, if the SB1 switch is on, the method proceeds to box 506. In box 506, the accessory load is transitioned to the first battery subpack by closing switches SA1 and SA2 and opening switches SB1 and SB2. The method then proceeds to box 508. In box 508, the second battery subpack is disconnected from the second charge port to terminate its charging. From box 508, the method proceeds to box 510.

In box 510, the charging mode of the first battery subpack is checked. If the charging mode for first battery subpack is not a constant current charging mode, the method proceeds directly to box 514. If the first battery subpack is in a constant current charging mode, the method proceeds to box 512. In box 512, the cell voltages of each cell of the first battery subpack are checked. If the voltage level for any of the cells of the first battery subpack is near or has reached a maximum voltage for the cell, the method proceeds to box 514. Otherwise, box 512 loops back into itself until this condition is met.

In box 514, the charging operation at the first charge port is switched to a constant voltage charging mode. In box 516, the SOC of the first battery subpack is observed. If the SOC of the first battery subpack has not reached an SOC limit for the first battery subpack, box 516 loops back into itself. Once the SOC of the first battery subpack has reached the SOC limit, the method proceeds to box 518. In box 518, the first battery subpack is disconnected from the first charging port to terminate the charging. At box 520, the charging is complete.

FIG. 6 is a continuation of the flowchart 300 of FIG. 3. Box 602 is entered from box 424 (FIG. 4). In box 602, the charging mode of the second battery subpack is checked. If the charging mode for second battery subpack is not a constant current charging mode, the method proceeds directly to box 606. If the second battery subpack is in a constant current charging mode, the method proceeds to box 604. In box 604, the cell voltages of each cell of the second battery subpack are checked. If the voltage level for any of the cells of the second battery subpack is near or has reached a maximum voltage for the cell, the method proceeds to box 606. Otherwise, box 604 loops back into itself until this condition is met.

In box 606, the charging operation at the second charge port is switched to a constant voltage charging mode.

In box 608, the SOC of the second battery subpack is observed. If the SOC of the second battery subpack has not reached an SOC limit for the second battery subpack, the box 608 loops back into itself. Once the SOC of the second battery subpack has reached the SOC limit, the method proceeds to box 610. In box 610, the second battery subpack is disconnected from the second charging port to terminate the charging. At box 612, the charging is complete.

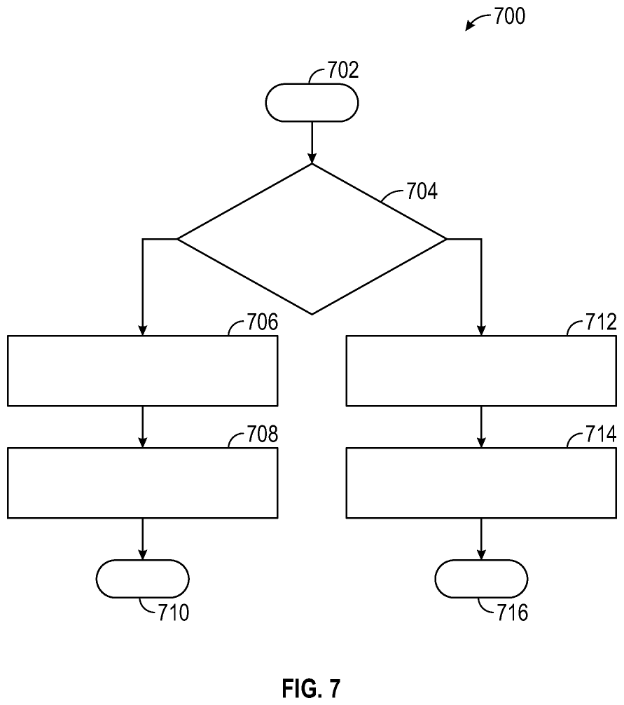

FIG. 7 shows a flowchart 700 of a method for switching an accessory load between battery subpacks. The method starts at box 702. In box 704, the battery subpack supplying power to the accessory load is identified. If the first battery subpack is supplying power, the method proceeds to box 706. If the second battery subpack is supplying power, the method proceeds to box 712.

Referring first to box 706, switches PCB and SB2 are closed and a short time duration (e.g., a few milliseconds) is waited through. In box 708, switch SB1 is closed and switches SA1 and SA2 are opened. In box 710, the method ends.

Referring now to box 712, switches PCA and SA2 are closed and a short time duration (e.g., a few milliseconds) is waited through. In box 714, switch SA1 is closed and switches SB1 and SB2 are opened. In box 716, the method ends.

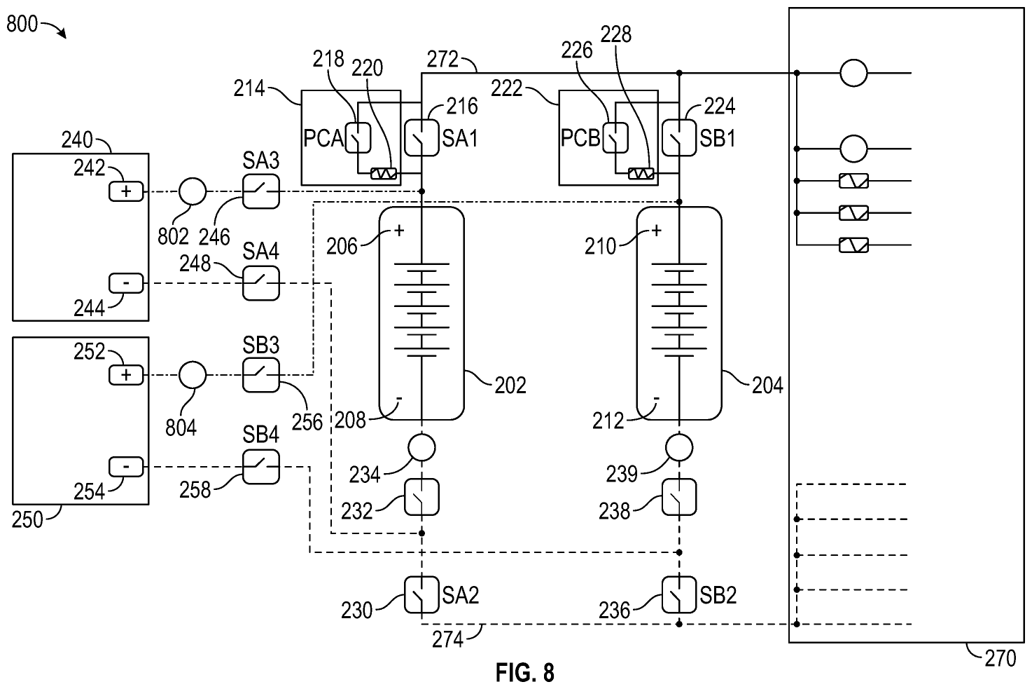

FIG. 8 shows a circuit diagram 800 of the electrical system 102, in a second embodiment. Instead of the first charge port fuse 260 shown in the first embodiment, a first charge port current sensor 802 is located at the first positive charge terminal 242. The first charge port current sensor 802 is in communication with the first fuse 232 (Pyro 1). When the first charge port current sensor 802 detects an overcurrent through the first charge port 240, it sends a signal to the first fuse 232 (Pyro 1) to activate or blow (i.e., open the circuit between the accessory loads 270 and the first battery subpack 202).

Similarly, a second charge port current sensor 804 is located at the second positive charge terminal 252. The second charge port current sensor 804 is in communication with the second fuse 238 (Pyro 2). When the second charge port current sensor 804 detects an overcurrent through the second charge port 250, it sends a signal to the second fuse 238 (Pyro 2) to activate or blow (i.e., open the circuit between the accessory loads 270 and the second battery subpack 204).

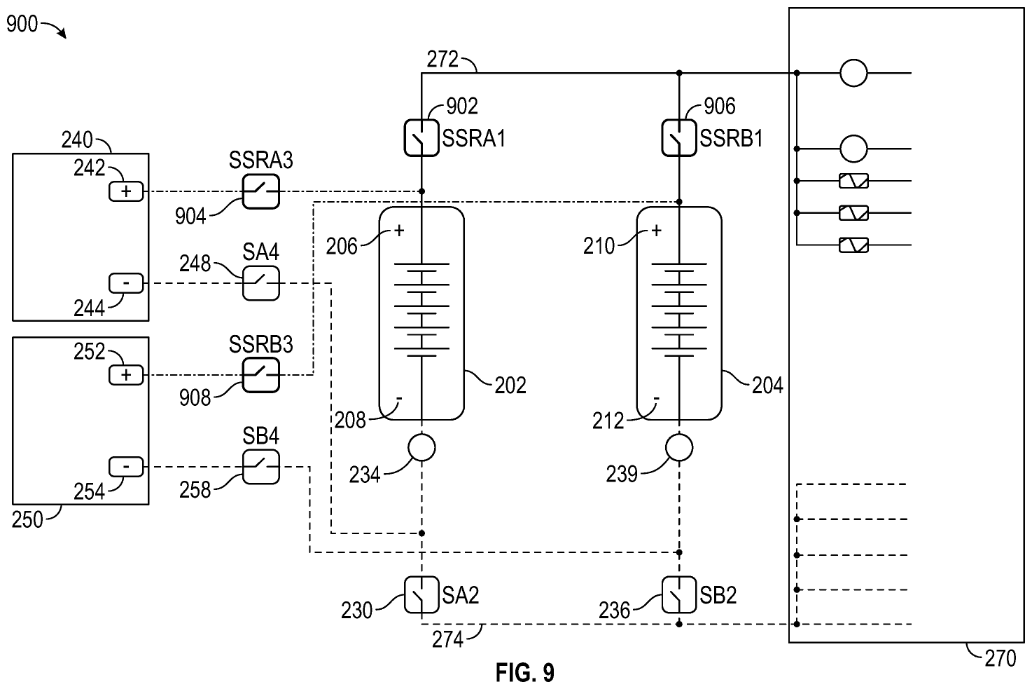

FIG. 9 shows a circuit diagram 900 of the electrical system 102, in a third embodiment. In comparison to the first embodiment, a first solid-state relay 902 (SSRA1) replaces the first pre-charge device 214 and main switch 216. Also, switch 246 (SA3) has been replaced by a second solid-state relay 904 (SSRA3) at the first positive charge terminal 242. The controller 112 can turn the first solid-state relay 902 on or off or make it act as a variable resistor. Also, the controller 112 can turn the second solid-state relay 904 on or off. The first fuse 232 (Pyro 1) has been removed altogether. The locations of solid-state relay 902 and switch 230 can be interchanged. Similarly, the locations of solid-state relay 904 and switch 248 can be interchanged. In another embodiment, all switches can be of solid-state type.

A third solid-state relay 906 (SSRB1) replaces the second pre-charge device 222 and main switch 224 of the first embodiment. Also, switch 256 has been replaced by a fourth solid-state relay 908 (SSRB3) at the second positive charge terminal 252. The controller 112 can turn the third solid-state relay 906 on or off or make it act as a variable resistor. Also, the controller 112 can turn the fourth solid-state relay 908 on or off. The second fuse 238 (Pyro 2) has been removed altogether. The locations of solid-state relay 906 and switch 236 can be interchanged. Similarly, locations of solid-state relay 908 and switch 258 can be interchanged. In another embodiment, all switches can be of solid-state type.

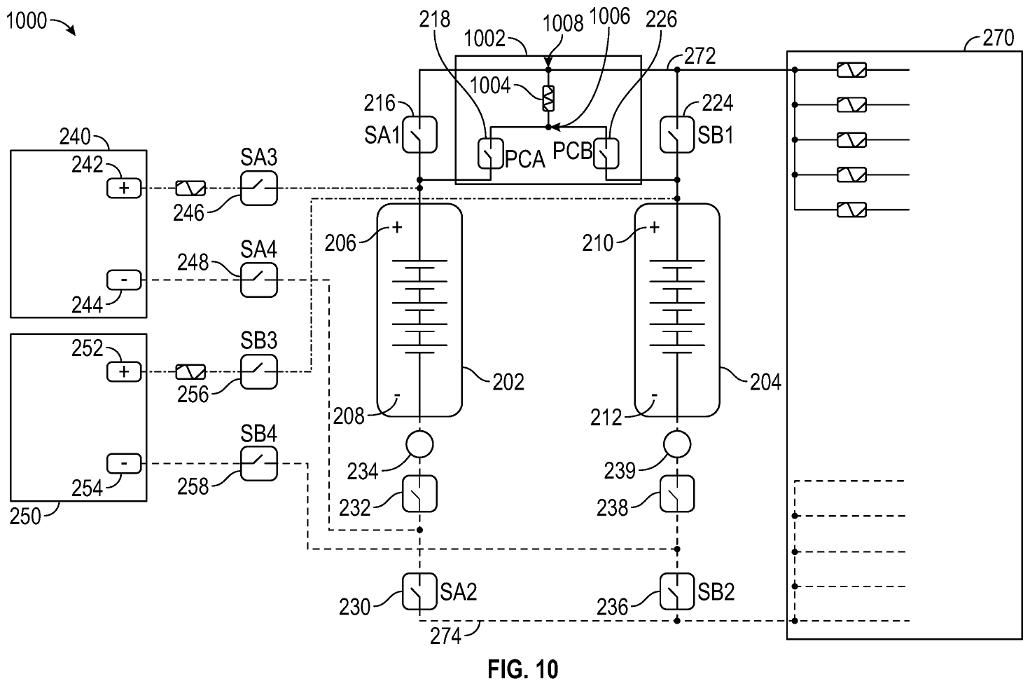

FIG. 10 shows a circuit diagram 1000 of the electrical system 102, in a fourth embodiment. The first pre-charge device 214 and the second pre-charge device 222 of the first embodiment have been replaced by a single pre-charge device 1002 that includes a single resistor 1004 that is shared between the first battery subpack 202 and the second battery subpack 204. The single pre-charge device 1002 includes the first pre-charge switch 218 (PCA), the second pre-charge switch 226 (PCB) and the single pred-charge device 1004. The first pre-charge switch 218 (PCA) and the second pre-charge switch 226 (PCB) connect from the first battery subpack 202 and the second battery subpack 204, respectively, to a first end 1006 of the single resistor 1004. The first main switch 216 (SA1) and the second main switch 224 (SB1) connect from their respective battery subpacks to a second end 1008 of the single resistor 1004. The second end 1008 is connected to the accessory loads 270.

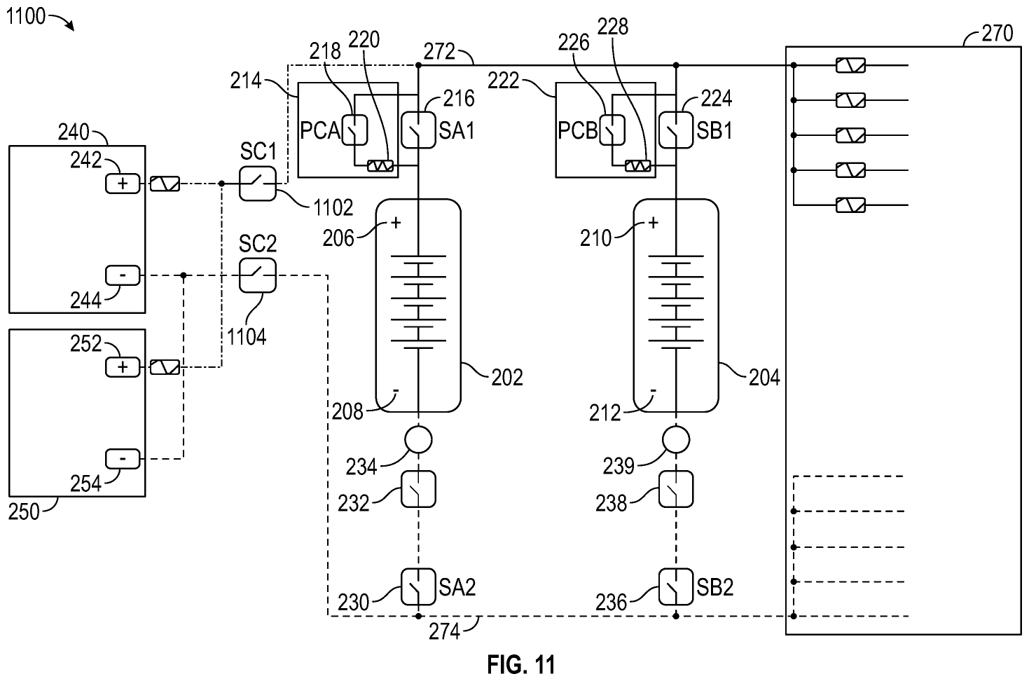

FIG. 11 shows a circuit diagram 1100 of the electrical system 102, in a fifth embodiment. In the fifth embodiment, the first positive charge terminal 242 of the first charge port 240 is electrically connected to the second positive charge terminal 252 of the second charge port 250. These charge ports can be coupled to the first positive terminal 206 of the first battery subpack 202 and the second positive terminal 210 of the second battery subpack 204 by a first charge switch 1102 (SC1).

Also, the first negative charge terminal 244 of the first charge port 240 is electrically connected to the second negative charge terminal 254 of the second charge port 250. These charge ports can be connected to the first negative terminal 208 of the first battery subpack 202 and the second negative terminal 212 of the second battery subpack 204 by a second charge switch 1104 (SC2).

Thus, the first charge port and the second charge port are electrically connected to each other. This is in distinction from the first embodiment in which the first connection is electrically isolated from the second connection.

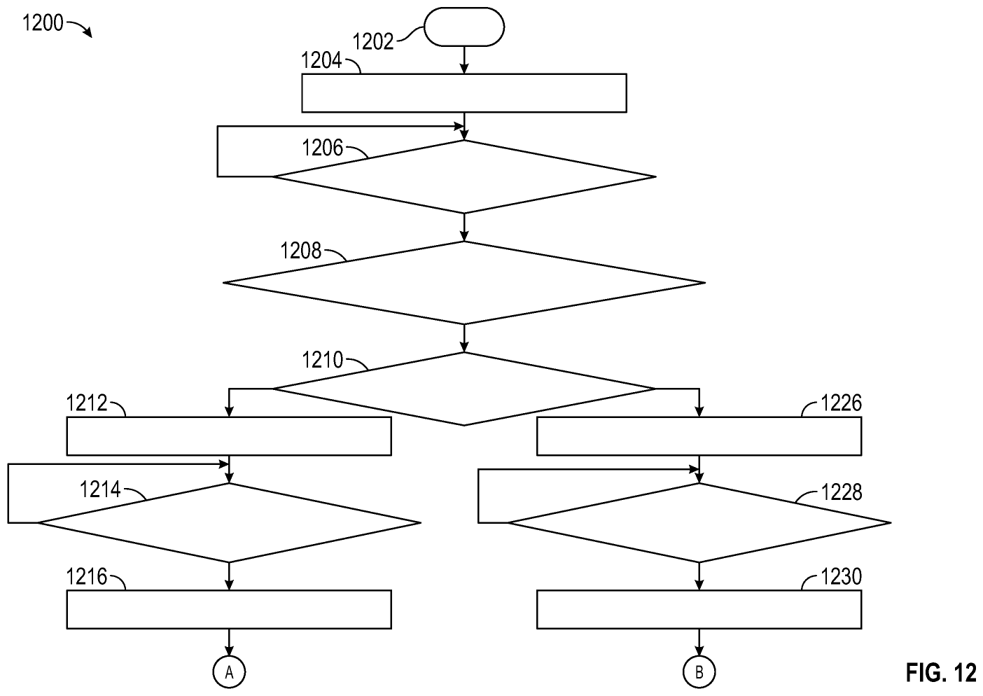

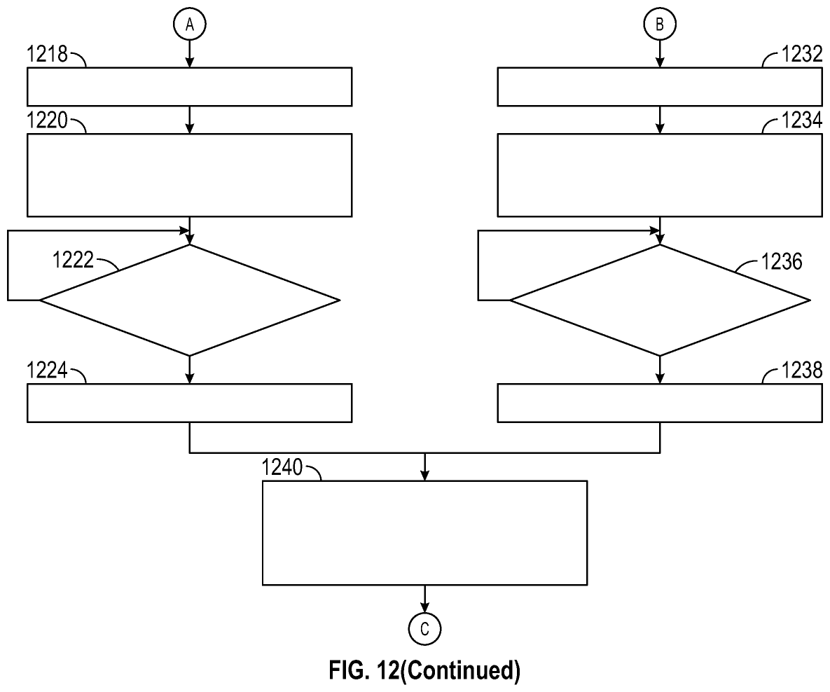

FIG. 12 shows a flowchart 1200 illustrating a charging method using the fifth embodiment of the electrical system shown in FIG. 11. The method starts at box 1202. In box 1204, all the switches are placed in the open configuration. In box 1206, a state of the charging ports is checked. If the charging ports are ready and set up for charging, the method proceeds to box 1208. Otherwise, box 1206 loops back into itself. In box 1208, the difference between the state of charge of the first battery subpack and the state of charge of the second battery subpack are compared to a first threshold. If an absolute value of the difference is less than the first threshold, the method proceeds to box 1210. In box 1210, the SOC of the first battery subpack is compared to the SOC of the second battery subpack. If the SOC of the first battery subpack is less than the SOC of the second battery subpack, the method proceeds to box 1212 for pre-charging and charging of the first battery subpack. Otherwise, the method proceeds to box 1226 for pre-charging and charging of the second battery subpack.

In box 1212, the switches first pre-charge switch PCA and first return switch SA2 are closed. In box 1214, the pre-charging operation is performed for the first battery subpack. Box 1214 loops back into itself until the pre-charging operation is complete at the first battery subpack. Once pre-charging is complete, the method proceeds to box 1216. In box 1216, first main switch SA1 is closed and first pre-charge switch PCA is opened. In box 1218, first charge switch SC1 and second charge switch SC2 are closed. In box 1220, current commands are set at the charge port to charge the first battery subpack in a constant current charging mode. In box 1222, the difference between the state of charge of the first battery subpack and the state of charge of the second battery subpack is compared to a second threshold. While an absolute value of this difference is greater than the second threshold, box 1222 loops back onto itself. Once the absolute value is less than or equal to the second threshold, the method proceeds to box 1224. In box 1224, second main switch SB1 and second return switch SB2 are closed.

Referring now to box 1226, switches second pre-charging switch PCB and second return switch SB2 are closed. In box 1228, the pre-charging operation is performed for the second battery subpack. Box 1228 loops back into itself until the pre-charging operation is complete at the second battery subpack. Once pre-charging is complete, the method proceeds to box 1230. In box 1230, switch second main switch SB1 is closed and second pre-charging switch PCB is opened.

In box 1232, first charge switch SC1 and second charge switch SC2 are closed. In box 1234, current commands are set at the charge port to charge the second battery subpack in a constant current charging mode. In box 1236, the difference between the state of charge of the first battery subpack and the state of charge of the second battery subpack are compared to a second threshold. While an absolute value of this difference is greater than the second threshold, box 1236 loops back onto itself. Once the absolute value is less than or equal to the second threshold, the method proceeds to box 1238. In box 1238, first main switch SA1 and first return switch SA2 are closed.

From either box 1224 or box 1238, the method proceeds to box 1240. In box 1240, the current commands are sent to the charge ports to produce a maximum constant current charging at both the first battery subpack and the second battery subpack.

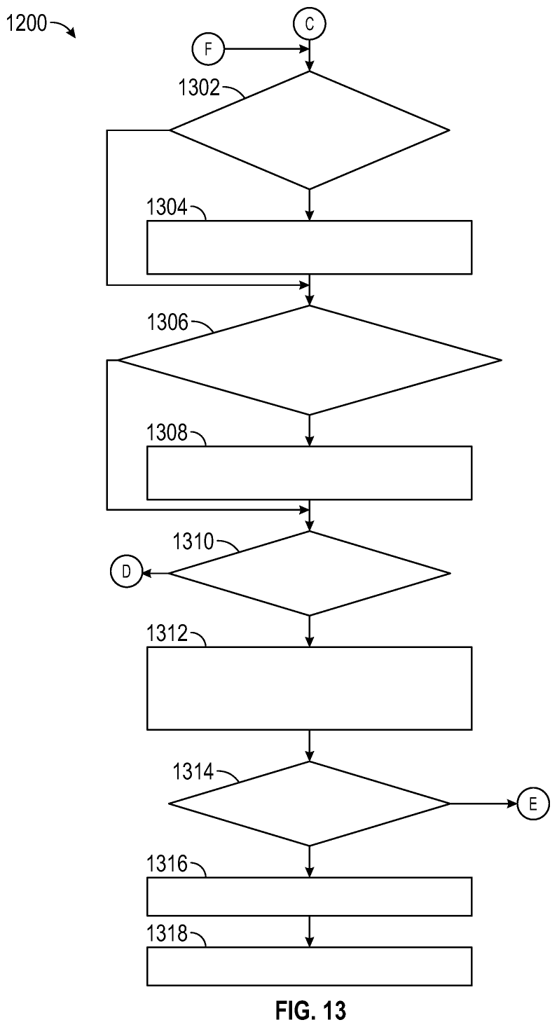

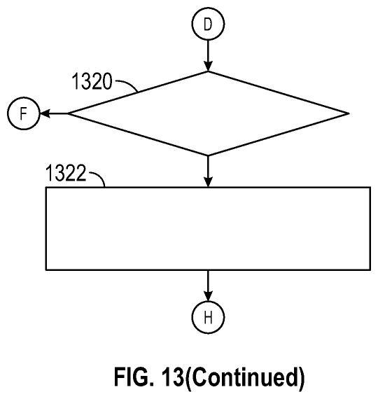

FIG. 13 is a continuation of the flowchart 1200 of FIG. 12. Box 1302 is entered from box 1240 of FIG. 12. In box 1302, the temperatures of the battery subpacks are monitored. If the temperatures of the battery subpacks are within a specified temperature range, the method proceeds directly to box 1306. However, if the temperature is not within a temperature range, the method proceeds to box 1304. In box 1304, the charging is derated for the battery subpacks that is outside of the temperature range. The method then proceeds to box 1306.

In box 1306, the cell voltages of both the first battery sub pack and the second battery subpack are compared to a voltage limit (a maximum voltage). If none of the cells of either the first battery subpack or the second battery subpack have a voltage level that is near or at a maximum voltage for the cell, the method proceeds directly to box 1310. However, if the voltage level of any cell of the first battery subpack or the second battery subpack is near or has reached the maximum voltage (within a criterion), the method proceeds to box 1308. In box 1308, the charging operation is switched from a constant current charging mode to a constant voltage charging mode. From box 1308, the method proceeds to box 1310.

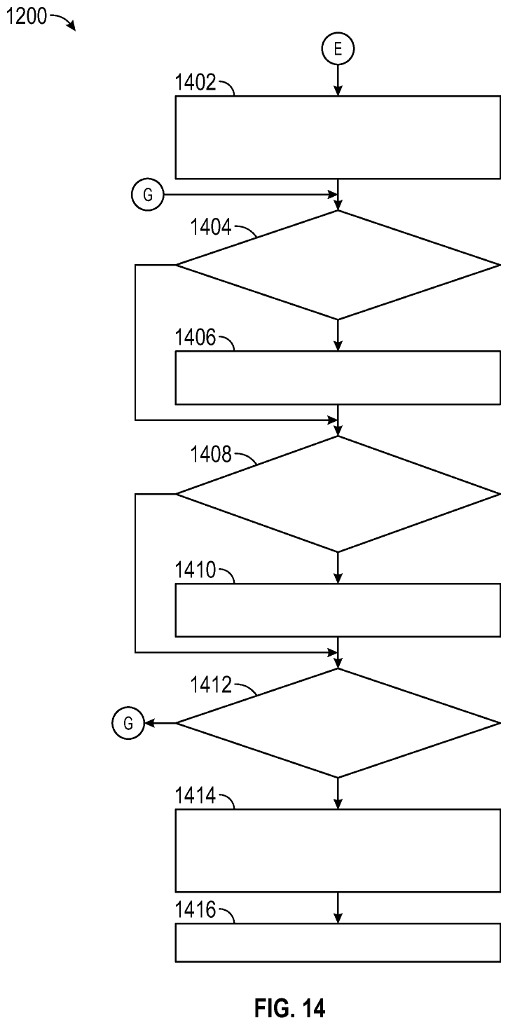

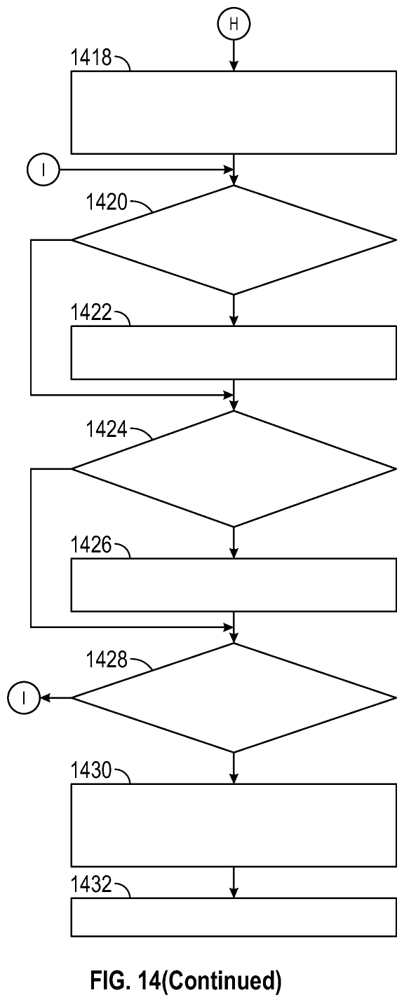

In box 1310, the state of charge for the first battery subpack is observed to see if the SOC is near an SOC limit. If the SOC has not reached the SOC limit, the method proceeds to box 1320. If the SOC has reached its limit, the method proceeds to box 1312. In box 1312, the charging current level is reduced to a specified safe low level and the first main switch SA1 and first return switch SA2 are opened. In box 1314, the state of charge for the second battery subpack is observed to see if the SOC is near an SOC limit. If the SOC has not reached the SOC limit, the method proceeds to box 1402 (FIG. 14). If the SOC has reached its limit, the method proceeds to box 1316. In box 1316, the second main switch SB1 and second return switch SB2 are opened. In box 1318, the method ends and charging is completed.

Referring now to box 1320, the state of charge for the second battery subpack is observed to see if the SOC is near an SOC limit. If the SOC has not reached the SOC limit, the method returns to box 1302. If the SOC has reached its limit, the method proceeds to box 1322. In box 1322, the charging current level is reduced to a specified safe low level and switches the second main switch SB1 and second return switch SB2 are opened. The method then proceeds to box 1418 (FIG. 14)

FIG. 14 is a continuation of the flowchart 1200 of FIG. 12. Box 1402 is entered from box 1314. In box 1402, current commands are sent to the charging ports to charge the second battery subpack using a constant current charging mode. In box 1404, the temperature of the second battery subpack is monitored. If the temperature of the second battery subpack is within a specified temperature range, the method proceeds directly to box 1408. However, if the temperature is not within a temperature range, the method proceeds to box 1406. In box 1406, the charging is derated. The method then proceeds to box 1408.

In box 1408, the cell voltages of the second battery subpack are compared to a voltage limit (a maximum voltage). For the second battery subpack, if none of the cells has a voltage level that is near or has reached a maximum voltage for the cell, the method proceeds directly to box 1412. However, if the voltage level for a cell is near or has reached the maximum voltage (within a criterion), the method proceeds to box 1410. In box 1410, the charging operation is switched from a constant current charging mode to a constant voltage charging mode. From box 1410, the method proceeds to box 1412.

In box 1412, the SOC of the second battery subpack is observed to see if the charging is complete at the second battery subpack. If the SOC has not reached an SOC limit, the method returns to box 1404. If the SOC has reached its limit, the method proceeds to box 1414. In box 1414, the charging current is reduced to a safe low level and the second main switch SB1 and the second return switch SB2 are opened. In box 1416, the method ends with the charging operation completed.

Referring now to box 1418, box 1418 is entered from box 1322 (FIG. 13). In box 1418, current commands are sent to the charging ports to charge the first battery subpack using a constant current charging mode. In box 1420, the temperature of the first battery subpack is monitored. If the temperature of the first battery subpack is within a specified temperature range, the method proceeds directly to box 1424. However, if the temperature is not within a temperature range, the method proceeds to box 1422. In box 1422, the charging is derated. The method then proceeds to box 1424.

In box 1424, the cell voltages of the first battery subpack are compared to a voltage limit (a maximum voltage). For the first battery subpack, if none of the cells has a voltage level that is near or has reached a maximum voltage for the cell, the method proceeds directly to box 1428. However, if the voltage level of a cell is near or has reached the maximum voltage (within a criterion), the method proceeds to box 1426. In box 1426, the charging operation is switched from a constant current charging mode to a constant voltage charging mode. From box 1426, the method proceeds to box 1428.

In box 1428, the SOC of the first battery subpack is observed to see if the charging is complete at the first battery subpack. If the SOC has not reached an SOC limit, the method returns to box 1420. If the SOC has reached its limit, the method proceeds to box 1430. In box 1430, the charging current is reduced to a safe low level and the first main switch SA1 and the first return switch SA2 are opened. In box 1432, the method ends with the charging operation completed.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of charging an electric vehicle, comprising:
detecting a first state of charge of a first battery subpack;
detecting a second state of charge of a second battery subpack;
determining a selected battery subpack from the first battery subpack and the second battery subpack for charging based on a comparison of the first state of charge and the second state of charge; and
connecting the selected battery subpack to a corresponding one of a first charge port and a second charge port.

2. The method of claim 1, further comprising charging the selected battery subpack in a constant current charging mode until a cell voltage of a battery cell of the selected battery subpack reaches a voltage threshold and charging the selected battery subpack using a constant voltage charging mode when the cell voltage of the battery cell is greater than the voltage threshold.

3. The method of claim 1, further comprising providing power from the selected battery subpack to an accessory load while the selected battery subpack is being charged and switching the accessory load off the selected battery subpack once the selected battery subpack is fully charged.

4. The method of claim 3, further comprising disconnecting the selected battery subpack from one of the first charge port and the second charge port when the selected battery subpack is fully charged.

5. The method of claim 3, wherein switching the accessory load further comprises pre-charging another battery subpack prior to connecting the accessory load to the other battery subpack.

6. The method of claim 1, wherein the first charge port and the second charge port are electrically connected and the selected battery subpack is selected by determining which of the first battery subpack and the second battery subpack has a greater state of charge.

7. The method of claim 6, further comprising pre-charging the selected battery subpack one and coupling the selected battery subpack to the first charge port and the second charge port prior to connecting another battery subpack to the first charge port and the second charge port.

8. A system for charging an electric vehicle, comprising:
a first battery subpack;
a second battery subpack;
a processor configured to:
determine a selected battery subpack from the first battery subpack and the second battery subpack for charging based on a comparison of a first state of charge of the first battery subpack a second state of charge of the second battery subpack; and
connect the selected battery subpack to a corresponding one of a first charge port and a second charge port.

9. The system of claim 8, wherein the processor is further configured to charge the selected battery subpack in a constant current charging mode until a cell voltage of a battery cell of the selected battery subpack reaches a voltage threshold and charge the selected battery subpack using a constant voltage charging mode when the cell voltage of the battery cell is greater than the voltage threshold.

10. The system of claim 8, wherein the processor is further configured to allow power to be provided from the selected battery subpack to an accessory load while the selected battery subpack is being charged and switch the accessory load off the selected battery subpack once the selected battery subpack is fully charged.

11. The system of claim 10, wherein the processor is further configured to disconnect the selected battery subpack from the corresponding one of the first charge port and the second charge port when the selected battery subpack is fully charged.

12. The system of claim 11, wherein the processor is further configured to pre-charge another battery subpack prior to connecting the accessory load to the other battery subpack.

13. The system of claim 8, wherein the first charge port and the second charge port are electrically connected and the processor is further configured to determine the selected battery subpack by determining which of the first battery subpack and the second battery subpack has a greater state of charge.

14. The system of claim 13, wherein the processor is further configured to pre-charge the selected battery subpack and couple the selected battery subpack to the first charge port and the second charge port prior to connecting another battery subpack to the first charge port and the second charge port.

15. An electric vehicle, comprising:
a first battery subpack;
a second battery subpack;
a processor configured to:
determine a selected battery subpack from the first battery subpack and the second battery subpack for charging based on a comparison of a first state of charge of the first battery subpack a second state of charge of the second battery subpack; and
connect the selected battery subpack to a corresponding one of a first charge port and a second charge port.

16. The electric vehicle of claim 15, wherein the processor is further configured to charge the selected battery subpack in a constant current charging mode until a cell voltage of a battery cell of the selected battery subpack reaches a voltage threshold and charge the selected battery subpack using a constant voltage charging mode when the cell voltage of the battery cell is greater than the voltage threshold.

17. The electric vehicle of claim 15, wherein the processor is further configured to allow power to be provided from the selected battery subpack to an accessory load while the selected battery subpack is being charged and switch the accessory load off the selected battery subpack once the selected battery subpack is fully charged.

18. The electric vehicle of claim 17, wherein the processor is further configured to disconnect the selected battery subpack from the corresponding one of the first charge port and the second charge port when the selected battery subpack is fully charged.

19. The electric vehicle of claim 18, wherein the processor is further configured to pre-charge another battery subpack prior to connecting the accessory load to the other battery subpack.

20. The electric vehicle of claim 15, wherein the first charge port and the second charge port are electrically connected and the processor is further configured to determine the selected battery subpack by determining which of the first battery subpack and the second battery subpack has a greater state of charge.
